(19) United States
(12) Patent Application Publication
(10) Pub. No.: US 2026/0079007 A1
(43) Pub. Date: Mar. 19, 2026

(54) CIRCUIT DEVICE AND PHYSICAL QUANTITY DETECTION DEVICE

(71) Applicant: SEIKO EPSON CORPORATION, Tokyo (JP)

(72) Inventors: Yuto Goi, Matsumoto-shi (JP); Hideo Haneda, Shiojiri-shi (JP)

(21) Appl. No.: 19/330,803

(22) Filed: Sep. 16, 2025

(30) Foreign Application Priority Data
Sep. 18, 2024 (JP) 2024-160856

(51) Int. Cl. G01C 19/5776; G01C 19/00

(52) U.S. Cl. CPC G01C 19/5776; G01C 19/005

(57) ABSTRACT

A circuit device includes a drive circuit that drives a driver in a physical quantity detection element and generates a periodic signal, based on a signal output from the driver; a detection circuit that generates a physical quantity detection signal related to a physical quantity detected by a detector in the physical quantity detection element, based on the signal output from the detector; and a bandpass filter circuit that receives the periodic signal and outputs a detection signal through a digital process. The detection circuit includes an analog front end that amplifies the signal output from the detector; an A/D conversion circuit that converts a signal output from the analog front end into a digital signal; and a demodulation circuit that demodulates a physical quantity signal contained in the digital signal output from the A/D conversion circuit, based on the detection signal. The detection circuit generates the physical quantity detection signal, based on the demodulated physical quantity signal.

The present application is based on, and claims priority from JP Application Serial Number 2024-160856, filed Sep. 18, 2024, the disclosure of which is hereby incorporated by reference herein in its entirety.

### BACKGROUND

### 1. Technical Field

The present disclosure relates to a circuit device and a physical quantity detection device.

### 2. Related Art

For various systems and electronic apparatuses, devices that can detect different physical quantities, such as gyro sensors for detecting angular velocity and acceleration sensors for detecting acceleration, are currently used. For example, JP-A-2008-224230 discloses a detection device that includes an amplifier circuit that amplifies a detection signal from a vibrator; a filter that performs a filtering process on the amplified detection signal; and an analog-to-digital (A/D) converter that sample-holds the processed detection signal, based on a sample hold signal obtained from a drive signal and A/D-converts the sample-held signal. The filter includes a bandpass filter having frequency characteristics of removing frequency components of unnecessary signals but allowing frequency components of a desired signal to pass therethrough. The detection device disclosed by JP-A-2008-224230 can provide an improved signal-to-noise (S/N) ratio because the bandpass filter can remove unnecessary signals at the previous stage of the sample-holding and the A/D conversion.

If the frequency of the drive signal is 50 kHz, for example, the detection signal from the vibrator can be modulated at 50 kHz. In this case, the bandpass filter in the detection device described in JP-A-2008-224230 needs to have a passband with a center frequency of 50 kHz. On the other hand, to satisfy the demand for a further low-noise detection signal, the bandpass filter needs to sufficiently attenuate the signal at 150 kHz so that noise generated by the third-order harmonics contained in the sample-held signal is not folded back into the signal band.

To satisfy the above conditions, the bandpass filter may be formed of an analog high-order circuit. In addition, an adjustment circuit is necessary to compensate for variations in the characteristics of the vibrator. As a result, the overall circuit scale may be disadvantageously large.

### SUMMARY

An aspect of the present disclosure is a circuit device connected to a physical quantity detection element that has a driver and a detector. The circuit device includes a drive circuit that drives the driver and that generates a periodic signal, based on a signal output from the driver; a detection circuit that generates a physical quantity detection signal related to a physical quantity detected by the detector, based on a signal output from the detector; and a bandpass filter circuit that receives the periodic signal and that outputs a detection signal through a digital process. The detection circuit includes an analog front end that amplifies the signal output from the detector; an analog-to-digital conversion circuit that converts a signal output from the analog front end into a digital signal; and a demodulation circuit that demodulates a physical quantity signal contained in the digital signal output from the analog-to-digital conversion circuit, based on the detection signal. The detection circuit generates the physical quantity detection signal, based on the demodulated physical quantity signal.

Another aspect of the present disclosure is a circuit device connected to a physical quantity detection element that has a driver and a detector. The circuit device includes a drive circuit that drives the driver and that generates a periodic signal, based on a signal output from the driver; a detection circuit that generates a physical quantity detection signal related to a physical quantity detected by the detector, based on a signal output from the detector. The detection circuit includes an analog front end that amplifies the signal output from the detector; an analog-to-digital conversion circuit that converts a signal output from the analog front end into a digital signal; a bandpass filter circuit that receives the digital signal output from the analog-to-digital conversion circuit; and a demodulation circuit that uses the periodic signal as a detection signal to demodulate a physical quantity signal contained in a signal output from the bandpass filter circuit, based on the detection signal. The detection circuit generates the physical quantity detection signal, based on the demodulated physical quantity signal.

A still another aspect of the present disclosure is a physical quantity detection device that includes an aspect of the circuit device and the physical quantity detection element.

### BRIEF DESCRIPTION OF THE DRAWINGS

FIG. 1 is a functional block diagram of a physical quantity detection device according to a first embodiment;

FIG. 2 is a plan view of a resonator element in the physical quantity detection element.

FIG. 3 is a diagram for explaining behavior of the physical quantity detection element.

FIG. 4 is another diagram for explaining the behavior of the physical quantity detection element.

FIG. 5 is a diagram of an example of a configuration of the drive circuit.

FIG. 6 is a diagram of an example of a configuration of the analog front end and the demodulation circuit.

FIG. 7 is a functional block diagram of a physical quantity detection device according to a second embodiment.

FIG. 8 is a diagram of an example of a configuration of the analog front end and the demodulation circuit.

FIG. 9 is a functional block diagram of a physical quantity detection device according to a third embodiment.

FIG. 10 is a functional block diagram of a physical quantity detection device according to a modification.

### DESCRIPTION OF EMBODIMENTS

Some preferred embodiments of the present disclosure will be described below in detail with reference to the accompanying drawings. It should be noted that the embodiments described below are not intended to unduly limit the contents of the present disclosure described in the claims. In addition, all the configurations described below may not be essential in the present disclosure.

Hereinafter, a physical quantity detection device, called an angular velocity detection device, that detects an angular velocity as a physical quantity will be described below as an example.

### 1. First Embodiment

### 1-1. Configuration of Physical Quantity Detection Device

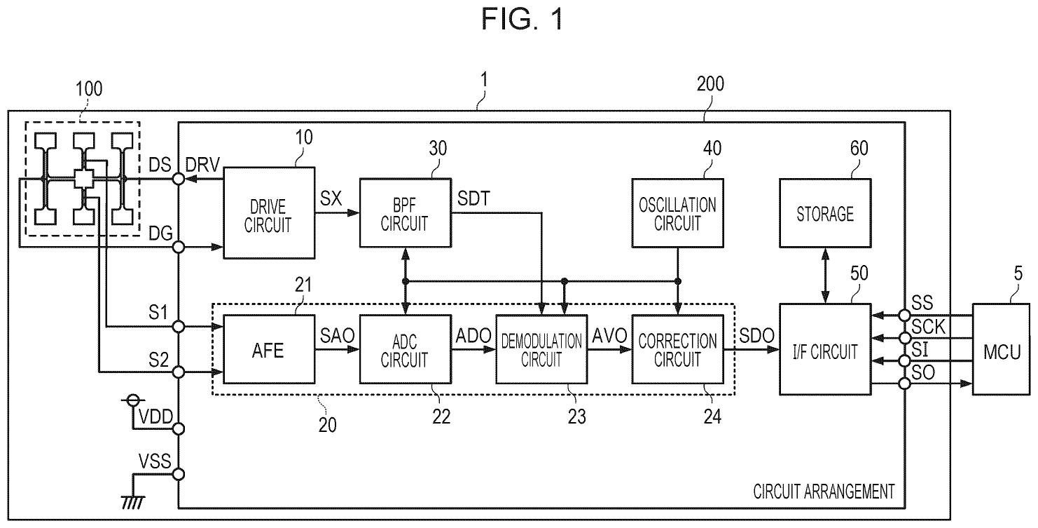

FIG. 1 is a functional block diagram of a physical quantity detection device according to the first embodiment. As illustrated in FIG. 1, a physical quantity detection device 1 in the first embodiment includes a physical quantity detection element 100 that detects a physical quantity; and a circuit device 200 connected to the physical quantity detection element 100. The circuit device 200 is implemented, for example, on a single integrated circuit (IC) chip. Both the physical quantity detection element 100 and the circuit device 200 are mounted in a package (not illustrated), such as a ceramic package.

The circuit device 200 includes terminals DS, DG, S1, S2, SS, SCK, SI, and SO as external connection terminals. The terminals DS, DG, S1, and S2 are electrically connected to the physical quantity detection element 100. The terminals SS, SCK, SI, and SO are electrically connected to an MCU 5, which is an external device of the circuit device 200. The MCU is an abbreviation of a micro control unit.

The physical quantity detection element 100 has a resonator element in which drive electrodes and detection electrodes are disposed. The resonator elements are typically encapsulated in a package with the airtightness thereof secured, so that it is possible to minimize the impedance of the resonator element and increase the oscillation efficiency. In the present embodiment, the physical quantity detection element 100 includes, as the resonator element, a so-called double T-shaped resonator element having two T-shaped drive vibration arms.

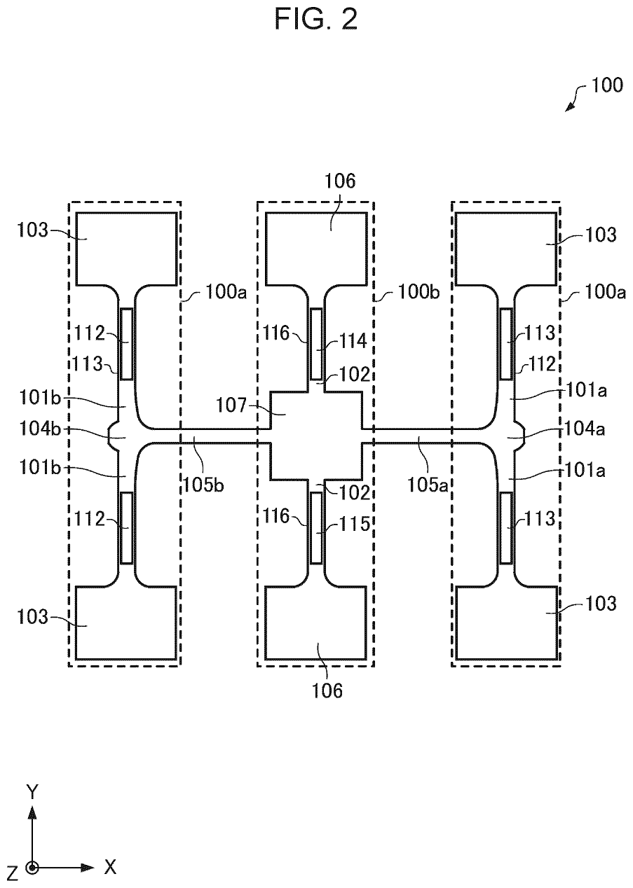

FIG. 2 is a plan view of the resonator element of the physical quantity detection element 100. The resonator element of the physical quantity detection element 100 may be made of quartz crystal (SiO₂). Such a quartz crystal resonator element advantageously provides greatly precise detection of angular velocity because the resonance frequency thereof does not largely vary with temperature. The physical quantity detection element 100 has, for example, a double T-shaped quartz crystal resonator element formed of a Z-cut quartz crystal substrate. It should be noted that the X-axis, the Y-axis, and the Z-axis in FIG. 2 indicate the respective axes of the quartz crystal.

As illustrated in FIG. 2, the physical quantity detection element 100 includes drivers 100a, a detector 100b, and a plurality of connection arms, or connection arms 105a and 105b, by which the detector 100b is connected to both the drivers 100a. The detector 100b includes a detection base 107; and a plurality of detection vibration arms 102 extending from the detection base 107. Of the drivers 100a, a first one includes a drive base 104a connected to the detection base 107 via the connection arm 105a; and a plurality of drive vibration arms 101a extending from the drive base 104a, and a second one includes a drive base 104b connected to the detection base 107 via the connection arm 105b; and a plurality of drive vibration arms 101b extending from the drive base 104b.

More specifically, in the resonator element of the physical quantity detection element 100, the drive vibration arms 101a extend from the drive base 104a, respectively, in the ±Y-axial directions, and the drive vibration arms 101b extend from the drive base 104b, respectively, in the ±Y-axial directions. Drive electrodes 112 and 113 are formed, respectively, on the upper and side surfaces of each drive vibration arm 101a; other drive electrodes 113 and 112 are formed, respectively, on the upper and side surfaces of each drive vibration arm 101b. The drive electrodes 112 and 113 are connected, respectively, to the terminal DG and the terminal DS of the circuit device 200 illustrated in FIG. 1.

The drive base 104a is connected to the detection base 107 having a rectangular shape via the connection arm 105a extending in the −X-axial direction; the drive base 104b is connected to the detection base 107 via the connection arm 105b extending in the +X-axial direction.

The detection vibration arms 102 extend from the detection base 107, respectively, in the ±Y-axial directions. Detection electrodes 114 and 115 are formed on the upper surfaces of the detection vibration arms 102; common electrodes 116 are formed on the side surfaces of the detection vibration arms 102. The detection electrodes 114 and 115 are connected, respectively, to the terminal S1 and terminal S2 of the circuit device 200 illustrated in FIG. 1. The common electrodes 116 are grounded.

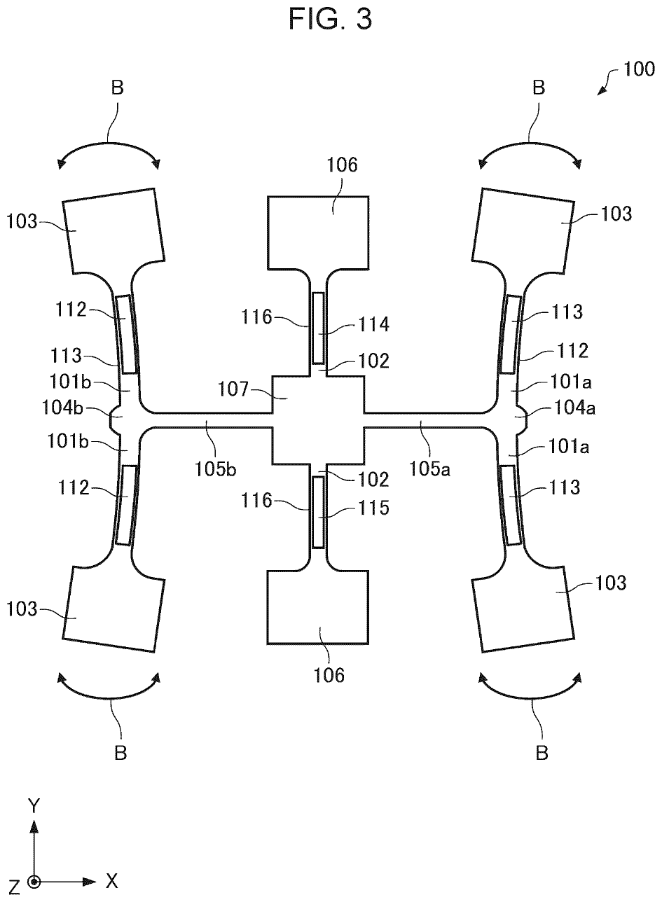

When an alternating current (AC) voltage is applied, as a drive signal, between the drive electrodes 112 and 113 of the drive vibration arms 101a and 101b, as illustrated in FIG. 3, the inverse piezoelectric effect occurs therebetween, thereby causing the drive vibration arms 101a and 101b to perform flexural vibrations with the ends of the two drive vibration arms 101a and 101b repeatedly moving close to and away from each other, as indicated by arrows B. In this case, the frequency of the flexural vibrations substantially coincides with the resonance frequency of each of the drive vibration arms 101a and 101b.

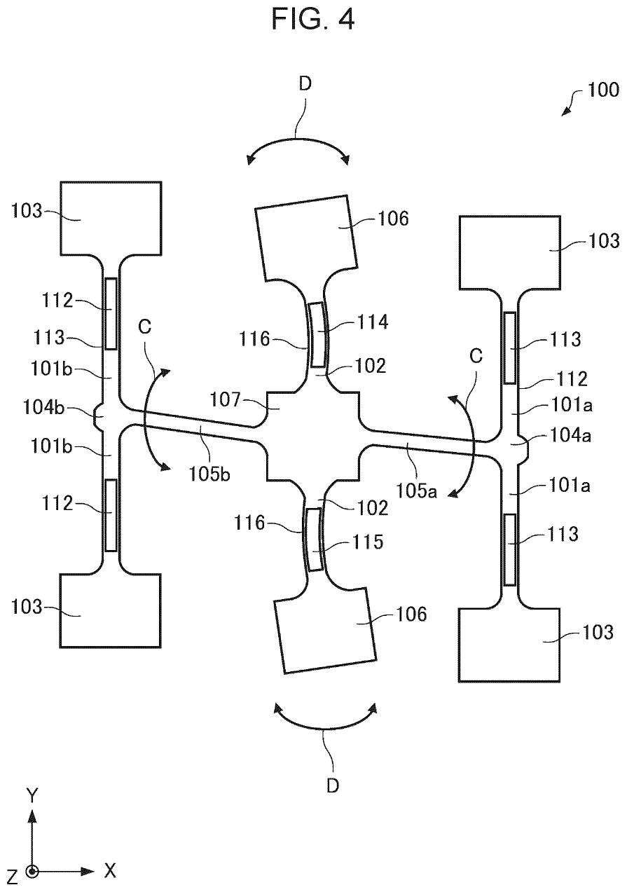

In the above state, when an angular velocity around the Z-axis, or the rotational axis, is applied to the resonator element of the physical quantity detection element 100, each of the drive vibration arms 101a and 101b is given a Coriolis force in a direction perpendicular to the Z-axis and the directions of the flexural vibrations indicated by arrows B. As a result, as illustrated in FIG. 4, each of the connection arms 105a and 105b vibrates as indicated by arrows C. In conjunction with the vibrations of the connection arms 105a and 105b, each detection vibration arm 102 performs a flexural vibration, as indicated by arrows D. The frequency of the flexural vibrations coincides with the frequency of the flexural vibration of each of the drive vibration arms 101a and 101b. The phase of the flexural vibration of each of the detection vibration arms 102 involved in the Coriolis force is shifted by 90° from the phase of the flexural vibration of each of the drive vibration arms 101a and 101b involved in the Coriolis force.

Because of the piezoelectric effect, AC charges based on these flexural vibrations are generated in the detection electrodes 114 and 115 of the detection vibration arms 102. In this case, the AC charges generated based on the Coriolis force change in accordance with the magnitude of the Coriolis force, namely, the magnitude of the angular velocity applied to the physical quantity detection element 100.

A weight section 103, which is wider than any of the drive vibration arms 101a and 101b, is formed at the end of each of the drive vibration arms 101a and 101b. By forming the weight section 103 at the end of each of the drive vibration arms 101a and 101b, a large amount of Coriolis force is generated, so that a desired resonance frequency can be obtained from the relatively short vibrating arms. Similarly, a weight section 106, which is wider than the detection vibration arms 102, is formed at the end of each detection vibration arm 102. By forming the weight section 106 at the end of each detection vibration arm 102, larger amounts of AC charges can be generated in the detection electrodes 114 and 115.

As described above, the physical quantity detection element 100 outputs, via the detection electrodes 114 and 115, an angular velocity signal, which is the AC charge based on the Coriolis force around the Z-axis, or the detection axis.

Returning to the explanation with reference to FIG. 1, the circuit device 200 includes a drive circuit 10, a detection circuit 20, a bandpass filter (BPF) circuit 30, an oscillation circuit 40, an interface (I/F) circuit 50, and a storage 60. In the circuit device 200, some of these components may be removed or replaced. Alternatively, some other elements may be added thereto.

The drive circuit 10 drives the drivers 100a of the physical quantity detection element 100 and generates a periodic signal SX based on a signal output from the drivers 100a. More specifically, the drive circuit 10 applies a drive signal DRV to the drive electrodes 113 of the physical quantity detection element 100 via the terminal DS, thereby exciting and vibrating the physical quantity detection element 100 in accordance with the drive signal DRV. The drive circuit 10 is then supplied, via the terminal DG, with an oscillation current generated in each drive electrode 112 in response to the excitation vibration of the physical quantity detection element 100 and performs feedback control of the amplitude level of the drive signal DRV such that the amplitude of the oscillation current is kept constant. The drive circuit 10 then generates the periodic signal SX having the same phase as the drive signal DRV and outputs the periodic signal SX to the BPF circuit 30. Details of the operation of the drive circuit 10 will be described later.

The BPF circuit 30 is a digital filter that receives the periodic signal SX and outputs a detection signal SDT through a digital process. The periodic signal SX, which is a rectangular wave signal, contains odd-order harmonics together with a fundamental mode thereof. The BPF circuit 30 whose center frequency is tuned to the frequency of the fundamental mode of the periodic signal SX allows the fundamental mode to pass therethrough while sufficiently attenuating the odd-order harmonics. If the frequency of the fundamental mode is 50 kHz, for example, the frequency of the third-order harmonics is 150 kHz, in which case the BPF circuit 30 serves as a digital filter whose passband contains 50 kHz and cutoff frequency is lower than 150 kHz on the high-frequency side.

The detection circuit 20 generates an angular velocity detection signal SDO related to the angular velocity detected by the detector 100b, based on a signal output from the detector 100b of the physical quantity detection element 100. More specifically, the detection circuit 20 generates a digital signal, or the angular velocity detection signal SDO, based on the signals output from the respective detection electrodes 114 and 115 of the physical quantity detection element 100 and then outputs the generated angular velocity detection signal SDO to the I/F circuit 50.

As illustrated in FIG. 1, the detection circuit 20 includes an analog front end (AFE) 21, an A/D conversion circuit (ADC) 22, a demodulation circuit 23, and a correction circuit 24.

The AFE 21 amplifies the signals output from the detector 100b of the physical quantity detection element 100. More specifically, the AFE 21 differentially amplifies the two signals output from the detection electrodes 114 and 115 of the physical quantity detection element 100 and then outputs an analog signal, or an amplified signal SAO.

The ADC circuit 22 converts the amplified signal SAO output from the AFE 21 into a digital signal ADO. The ADC circuit 22 may be a delta-sigma A/D conversion circuit that outputs a 1-bit digital signal ADO. Because of the noise-shaping effect thereof, the delta-sigma A/D conversion circuit reduces noise contained in the digital signal ADO within the signal band.

The demodulation circuit 23 demodulates an angular velocity signal AVO, which is a physical quantity signal contained in the digital signal ADO output from the ADC circuit 22, based on the detection signal SDT output from the BPF circuit 30. In the present embodiment, the demodulation circuit 23 uses the digital signal ADO output from the ADC circuit 22 as a detected signal to mix the digital signal ADO, which is the detected signal, with the detection signal SDT, thereby demodulating the angular velocity signal AVO.

The correction circuit 24 subjects the angular velocity signal AVO to various types of correction processes, such as a low-pass filter process, an offset correction, a temperature correction, and a sensitivity correction. The signal obtained through the process of the correction circuit 24 is output from the detection circuit 20 to the I/F circuit 50 as the angular velocity detection signal SDO, which is a physical quantity detection signal.

In the above way, the detection circuit 20 generates the angular velocity detection signal SDO, based on the angular velocity signal AVO demodulated by the demodulation circuit 23. Alternatively, without performing any process, the detection circuit 20 may output the angular velocity signal AVO as the angular velocity detection signal SDO to the MCU 5 via the I/F circuit 50, and the MCU 5 may perform a low pass filter process or various correction processes on the angular velocity detection signal SDO.

Each of the BPF circuit 30, the demodulation circuit 23, and the correction circuit 24 is a digital circuit and operates in synchronization with a master clock signal MCLK. At least some of the functions of the BPF circuit 30, the demodulation circuit 23, and the correction circuit 24 may be implemented by a DSP. The DSP is an abbreviation for a digital signal processor.

The storage 60 has a nonvolatile memory (not illustrated), which stores various pieces of trimming data to be used by the drive circuit 10 and the detection circuit 20. The nonvolatile memory may be a MONOS memory or an EEPROM, for example. The MONOS is an abbreviation for metal oxide nitride oxide silicon. The EEPROM is an abbreviation of electrically erasable programmable read-only memory. Furthermore, the storage 60 has a register (not illustrated). When the circuit device 200 is turned on, namely, when the voltage at a terminal VDD rises from 0 V to a desired value, various pieces of trimming data that have been stored in the nonvolatile memory may be transferred to the register and retained therein. Then, the trimming data that have been retained in the register may be supplied to the drive circuit 10 or the detection circuit 20.

The oscillation circuit 40 generates the master clock signal MCLK and then supplies the master clock signal MCLK to the ADC circuit 22, the demodulation circuit 23, the correction circuit 24, and the BPF circuit 30. The oscillation circuit 40 may generate the master clock signal MCLK by using, for example, a ring oscillator or a CR oscillation circuit.

In response to a request from the MCU 5, which is an external device of the circuit device 200, the I/F circuit 50 performs a process of outputting the angular velocity detection signal SDO output from the detection circuit 20 to the MCU 5.

In response to another request from the MCU 5, the I/F circuit 50 performs a process of reading data stored in the nonvolatile memory and the registers of the storage 60 and outputting the data to the MCU 5 or a process of writing data input from the MCU 5 to the nonvolatile memory and the registers of the storage 60.

The I/F circuit 50, which is an interface circuit of an SPI bus, for example, receives a selection signal, a clock signal, and a data signal transmitted from the MCU 5, respectively, via the terminals SS, SCK, and SI of the circuit device 200 and, in turn, outputs a data signal to the MCU 5 via the terminal SO of the circuit device 200. The SPI is an abbreviation for serial peripheral interface. In this case, the I/F circuit 50 may be an interface circuit that supports various buses, including an I²C bus, for example, other than the SPI bus. The I²C is an abbreviation for inter-integrated circuit.

### 1-2. Configuration of Drive Circuit

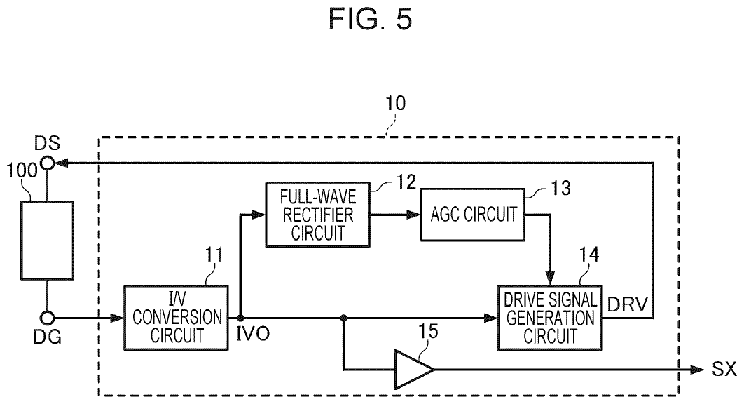

FIG. 5 is a diagram of an example of a configuration of the drive circuit 10. As illustrated in FIG. 5, the drive circuit 10 includes an I/V conversion circuit 11, a full-wave rectifier circuit 12, an automatic gain control (AGC) circuit 13, a drive signal generation circuit 14, and a buffer circuit 15.

When the physical quantity detection element 100 is excited and vibrates to generate an oscillation current through the drive electrodes 112, this oscillation current is supplied to the I/V conversion circuit 11 via the terminal DG and is then converted into an AC voltage signal IVO by the I/V conversion circuit 11. The AC voltage signal IVO output from the I/V conversion circuit 11 enters the full-wave rectifier circuit 12, the drive signal generation circuit 14, and the buffer circuit 15.

The full-wave rectifier circuit 12 performs full-wave rectification on the AC voltage signal IVO output from the I/V conversion circuit 11 and then outputs a direct current (DC) signal.

The AGC circuit 13 amplifies the signal output from the full-wave rectifier circuit 12 and then outputs a signal having a predetermined voltage. The AGC circuit 13 controls the amplification gain in accordance with the magnitude of the signal output from the full-wave rectifier circuit 12 such that the output signal is kept at a predetermined voltage.

The drive signal generation circuit 14 binarizes the AC voltage signal IVO to generate the drive signal DRV and then outputs the drive signal DRV. The high-level voltage of the drive signal DRV corresponds to the voltage of the signal output from the AGC circuit 13 and is kept at the predetermined voltage. The drive signal DRV is supplied to each drive electrode 113 of the physical quantity detection element 100 via the terminal DS. By receiving the drive signal DRV, the physical quantity detection element 100 can continue the excitation and the vibration. Furthermore, since the high-level voltage of the drive signal DRV is kept constant, the drive vibration arms 101a and 101b of the physical quantity detection element 100 can vibrate at a constant speed. Therefore, the vibration speed, which is the cause of generating the Coriolis force, can be made more constant to provide stabler sensitivity.

The buffer circuit 15 receives the AC voltage signal IVO and then outputs the periodic signal SX, which is a rectangular wave signal having the same phase as the AC voltage signal IVO. The periodic signal SX is supplied to the BPF circuit 30. In this case, a filter may be provided between the output of the I/V conversion circuit 11 and the input of the buffer circuit 15.

### 1-3. Configuration of Analog Front End and Demodulation Circuit

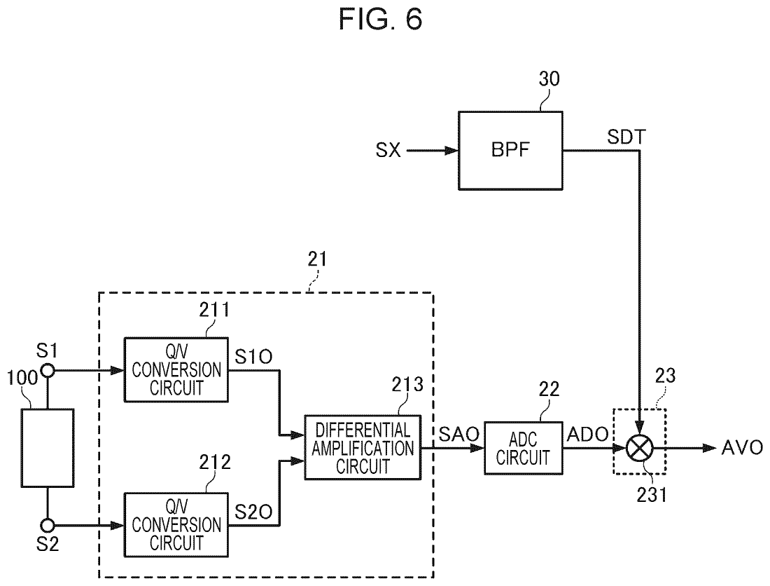

FIG. 6 is a diagram of an example of a configuration of the AFE 21 and the demodulation circuit 23. As illustrated in FIG. 6, the AFE 21 includes Q/V conversion circuits 211 and 212 and a differential amplification circuit 213.

The Q/V conversion circuit 211 is supplied with, via the terminal S1, an AC charge generated through the detection electrode 114 of the physical quantity detection element 100. The Q/V conversion circuit 212 is supplied with, via the terminal S2, an AC charge generated through the detection electrode 115 of the physical quantity detection element 100.

In the present embodiment, as illustrated in FIG. 2, when an angular velocity is applied to the physical quantity detection element 100, the detection vibration arm 102 on which the detection electrode 114 is formed and the detection vibration arm 102 on which the detection electrode 115 is formed perform flexural vibrations in mutually opposite directions so as to be kept in balance. For this reason, the angular velocity signal contained in the AC charge generated in the detection electrode 114 and the angular velocity signal contained in the AC charge generated in the detection electrode 115 have mutually opposite phases. Herein, cases where two angular velocity signals have mutually opposite phases include a case where the difference in phase between the two angular velocity signals is exactly 180° as well as a case where the difference in phase between the two angular velocity signals slightly deviates from 180°, for example, due to an error caused during the manufacturing of the physical quantity detection element 100 and an error involved in the delay time of the signal propagation path.

The Q/V conversion circuit 211 converts the AC charge supplied through the detection electrode 114 of the physical quantity detection element 100 into an AC voltage signal S1O and then outputs the AC voltage signal S1O. Likewise, the Q/V conversion circuit 212 converts the AC charge supplied through the detection electrode 115 of the physical quantity detection element 100 into an AC voltage signal S2O and then outputs the AC voltage signal S2O.

The differential amplification circuit 213 receives a differential signal pair formed of both the AC voltage signal S1O output from the Q/V conversion circuit 211 and the AC voltage signal S2O output from the Q/V conversion circuit 212, then amplifies the difference between the AC voltage signal S1O and the AC voltage signal S2O, and outputs an amplified signal SAO. The angular velocity signal contained in the amplified signal SAO has substantially the same phase as the drive signal DRV and is a signal modulated at, for example, several tens of kHz, which corresponds to the frequency of the drive signal DRV.

The amplified signal SAO enters the ADC circuit 22. As described above, the ADC circuit 22 converts the amplified signal SAO output from the AFE 21 into the digital signal ADO and then outputs the digital signal ADO to the demodulation circuit 23. For example, the ADC circuit 22 is a delta-sigma A/D conversion circuit that operates in synchronization with the master clock signal MCLK and outputs a 1-bit digital signal ADO. For example, the frequency of the master clock signal MCLK is several tens of MHz. Because of the noise-shaping effect thereof, the delta-sigma A/D conversion circuit provides the digital signal ADO in which noise contained within a signal band of, for example, several tens of kHz has been effectively reduced.

The demodulation circuit 23 includes a mixing circuit 231. The mixing circuit 231 uses the digital signal ADO output from the ADC circuit 22 as the detected signal to mix the digital signal ADO, which is the detected signal, with the detection signal SDT output from the BPF circuit 30. In short, the mixing circuit 231 outputs a digital signal obtained by multiplying the digital signal ADO by the detection signal SDT. If the digital signal ADO is a 1-bit digital signal and the detection signal SDT is a 16-bit digital signal, for example, the mixing circuit 231 outputs a 16-bit digital signal, which becomes 0 when the value of the digital signal ADO is 0 and becomes the digital value of the detection signal SDT when the value of the digital signal ADO is 1.

The angular velocity signal contained in the digital signal ADO has substantially the same phase as the periodic signal SX. Since the phase of the detection signal SDT is substantially the same as the phase of the periodic signal SX, the phase of the angular velocity signal contained in the digital signal ADO is substantially the same as the phase of the detection signal SDT. Therefore, the mixing circuit 231 demodulates the angular velocity signal contained in the digital signal ADO and then outputs an output signal as the angular velocity signal AVO from the demodulation circuit 23 to the correction circuit 24.

As described above, the BPF circuit 30 is a digital filter that receives the periodic signal SX and outputs a digital signal obtained by sufficiently attenuating harmonics contained in the periodic signal SX. Using the digital signal output from the BPF circuit 30 as the detection signal SDT as in the present embodiment, the mixing circuit 231 can reduce harmonic noise within the frequency band which is to be folded back into the signal band, so that it is possible to demodulate the angular velocity signal AVO with great precision. Furthermore, being formed as a digital circuit, the BPF circuit 30 does not involve a large circuit area and a large amount of power consumption, compared to a case where the BPF circuit 30 is formed as an analog circuit.

### 1-4. Function and Effect

According to a physical quantity detection device 1 in the first embodiment, a circuit device 200 includes a BPF circuit 30 that outputs a detection signal SDT obtained by sufficiently attenuating harmonics contained in a periodic signal SX. Thus, when demodulating an angular velocity signal AVO based on the detection signal SDT, a demodulation circuit 23 can suppress high-frequency noise generated by harmonics contained in the detection signal SDT from being folded back into the signal band. Furthermore, being formed as a digital circuit, the BPF circuit 30 does not involve a large circuit area and a large amount of power consumption, compared to a case where the BPF circuit 30 is formed as an analog circuit. Therefore, the physical quantity detection device 1 in the first embodiment can provide a low-noise physical quantity detection signal with a small scale of circuitry in circuit device 200.

According to the physical quantity detection device 1 in the first embodiment, using a digital circuit to perform a bandpass filter process and a process of demodulating the angular velocity signal AVO, the circuit device 200 can reduce low-frequency noise, such as 1/f noise, generated in the angular velocity detection signal SDO within the signal band, compared to the related art in which an analog circuit performs a bandpass filter process or a demodulation process. Therefore, with the physical quantity detection device 1 in the first embodiment, the circuit device 200 can provide a low-noise angular velocity detection signal SDO.

According to the physical quantity detection device 1 in the first embodiment, being formed as a delta-sigma A/D conversion circuit, an ADC circuit 22 in the circuit device 200 reduces noise contained in a digital signal ADO within the signal band, because of the noise-shaping effect of the delta-sigma A/D conversion circuit. Moreover, being formed as a delta-sigma A/D conversion circuit, the ADC circuit 22 generates a 1-bit digital signal ADO. Therefore, a mixing circuit 231 included in the demodulation circuit 23 can be implemented in a simple configuration so that a compact circuit device 200 can be realized.

### 2. Second Embodiment

Hereinafter, components in a second embodiment which are similar to those in the foregoing first embodiment are denoted by the same reference numerals. In addition, the components that have already been described in the first embodiment will not be described or will be described briefly. Thus, the description will be mainly focused on components different from those in the first embodiment.

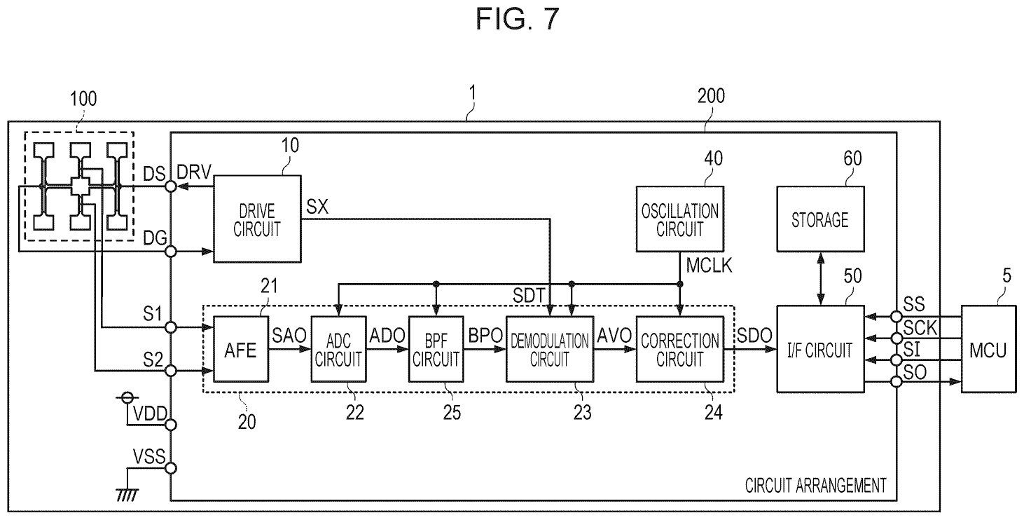

FIG. 7 is a functional block diagram of a physical quantity detection device 1 according to the second embodiment. As illustrated in FIG. 7, the physical quantity detection device 1 in the second embodiment includes a physical quantity detection element 100 and a circuit device 200. Since the configuration of the physical quantity detection element 100 is the same as in the first embodiment, the description thereof will not be given.

The circuit device 200 includes a drive circuit 10, a detection circuit 20, an oscillation circuit 40, an interface (I/F) circuit 50, and a storage 60. In the circuit device 200, some of these components may be removed or replaced. Alternatively, some other elements may be added thereto.

Similar to the first embodiment, the drive circuit 10 drives drivers 100a of the physical quantity detection element 100 and generates a periodic signal SX based on a signal output from the drivers 100a. In the second embodiment, the drive circuit 10 outputs the generated periodic signal SX to a demodulation circuit 23 in the detection circuit 20.

Similar to the first embodiment, the detection circuit 20 generates an angular velocity detection signal SDO related to the angular velocity detected by a detector 100b of the physical quantity detection element 100, based on a signal output from the detector 100b. Similar to the first embodiment, as illustrated in FIG. 7, the detection circuit 20 includes an analog front end (AFE) 21, an A/D conversion (ADC) circuit 22, the demodulation circuit 23, and a correction circuit 24 and further includes a bandpass filter (BPF) circuit 25.

The AFE 21 amplifies the signals output from the detector 100b of the physical quantity detection element 100. More specifically, the AFE 21 differentially amplifies the two signals output from the detection electrodes 114 and 115 of the physical quantity detection element 100 and then outputs an analog signal, or an amplified signal SAO.

The ADC circuit 22 converts the amplified signal SAO output from the AFE 21 into a digital signal ADO. The ADC circuit 22 may be a delta-sigma A/D conversion circuit that outputs a 1-bit digital signal ADO. Because of the noise-shaping effect thereof, the delta-sigma A/D conversion circuit reduces noise contained in the digital signal ADO within the signal band.

The BPF circuit 25 is a digital filter that receives the digital signal ADO output from the ADC circuit 22 and then outputs a digital signal BPO through a digital process. Since the signals output from the detector 100b of the physical quantity detection element 100 are modulated at the frequency of a drive signal DRV, the digital signal ADO is also modulated at that frequency. Since the frequency of the periodic signal SX coincides with the frequency of the drive signal DRV, the BPF circuit 25 has a passband whose center frequency is tuned to the frequency of the fundamental mode of the periodic signal SX and which sufficiently attenuates noise of frequencies that are odd multiples of the center frequency. If the frequency of the fundamental mode of the periodic signal SX is 50 kHz, for example, the BPF circuit 25 serves as a digital filter that has a passband containing 50 kHz and a cutoff frequency lower than 150 kHz on the high-frequency side.

The demodulation circuit 23 uses the periodic signal SX output from the drive circuit 10 as a detection signal to demodulate an angular velocity signal AVO, which is a physical quantity signal contained in the digital signal BPO output from the BPF circuit 25, based on the periodic signal SX, which is a detection signal. In the present embodiment, the demodulation circuit 23 uses the digital signal BPO output from the BPF circuit 25 as a detected signal to mix the digital signal BPO, which is the detected signal, with the periodic signal SX, which is the detection signal, thereby demodulating the angular velocity signal AVO.

The correction circuit 24 subjects the angular velocity signal AVO to various types of correction processes, such as a low-pass filter process, an offset correction, a temperature correction, and a sensitivity correction. The signal obtained through the process of the correction circuit 24 is output from the detection circuit 20 to the I/F circuit 50 as the angular velocity detection signal SDO, which is a physical quantity detection signal.

In the above way, the detection circuit 20 generates the angular velocity detection signal SDO, based on the angular velocity signal AVO demodulated by the demodulation circuit 23. Alternatively, without performing any process, the detection circuit 20 may output the angular velocity signal AVO as the angular velocity detection signal SDO to the MCU 5 via the I/F circuit 50, and the MCU 5 may perform a low pass filter process or various correction processes on the angular velocity detection signal SDO.

Since the configurations and processes of the oscillation circuit 40, the I/F circuit 50, and the storage 60 are the same as in the first embodiment, the description thereof will not be given.

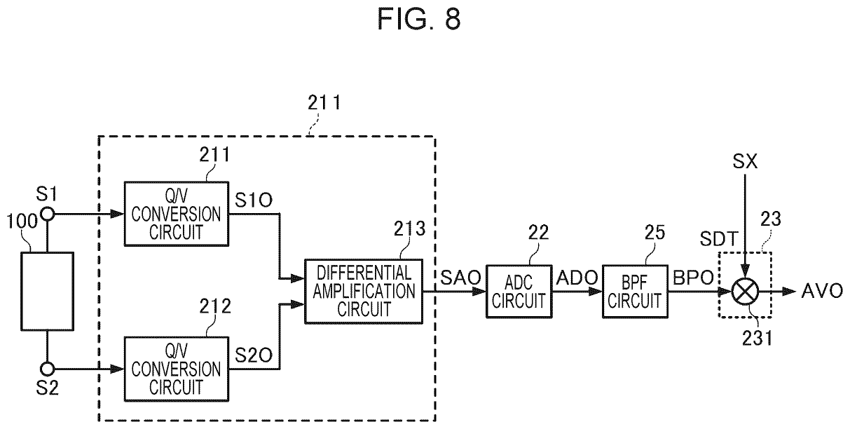

FIG. 8 is a diagram of an example of a configuration of the AFE 21 and the demodulation circuit 23. As illustrated in FIG. 8, the AFE 21 includes Q/V conversion circuits 211 and 212 and a differential amplification circuit 213, similar to the first embodiment.

The Q/V conversion circuit 211 is supplied with, via the terminal S1, an AC charge generated through the detection electrode 114 of the physical quantity detection element 100. Then, the Q/V conversion circuit 211 converts the AC charge into an AC voltage signal S1O and outputs the AC voltage signal S1O. The Q/V conversion circuit 212 is supplied with, via the terminal S2, an AC charge generated through the detection electrode 115 of the physical quantity detection element 100. Then, the Q/V conversion circuit 212 converts the AC charge into an AC voltage signal S2O and outputs the AC voltage signal S2O.

The differential amplification circuit 213 receives a differential signal pair formed of both the AC voltage signal S1O output from the Q/V conversion circuit 211 and the AC voltage signal S2O output from the Q/V conversion circuit 212, then amplifies the difference between the AC voltage signal S1O and the AC voltage signal S2O, and outputs an amplified signal SAO.

As described above, the ADC circuit 22 converts the amplified signal SAO output from the AFE 21 into the digital signal ADO and outputs the digital signal ADO to the BPF circuit 25.

As described above, the BPF circuit 25 receives the digital signal ADO output from the ADC circuit 22 and outputs the digital signal BPO.

The demodulation circuit 23 includes a mixing circuit 231. The mixing circuit 231 uses the digital signal BPO output from the BPF circuit 25 as the detected signal to mix the digital signal BPO, which is the detected signal, with the periodic signal SX, which is the detection signal. In short, the mixing circuit 231 outputs a digital signal obtained by multiplying the digital signal BPO by the periodic signal SX. If the digital signal BPO is a 16-bit digital signal and the periodic signal SX is a 1-bit digital signal, for example, the mixing circuit 231 outputs a 16-bit digital signal, which becomes 0 when the value of the periodic signal SX is 0 and becomes the digital value of the digital signal BPO when the value of the periodic signal SX is 1.

The angular velocity signal contained in the digital signal BPO has substantially the same phase as the periodic signal SX. Therefore, the mixing circuit 231 demodulates the angular velocity signal contained in the digital signal BPO and then outputs an output signal as the angular velocity signal AVO from the demodulation circuit 23 to the correction circuit 24.

As described above, the BPF circuit 25 is a digital filter that receives the digital signal ADO and then outputs the digital signal BPO obtained by reducing, contained in the digital signal ADO, noise whose frequencies are odd multiples of the frequency of the fundamental mode of the periodic signal SX. Therefore, using the digital signal BPO as the detected signal as in the present embodiment, the mixing circuit 231 removes almost all noise within the frequency bands which are odd-order harmonics of the periodic signal SX and which is to be folded back into the signal band. It is thereby possible to demodulate the angular velocity signal AVO with great precision.

Other configurations of the physical quantity detection device 1 in the second embodiment are the same as in the first embodiment, and descriptions thereof will not be given accordingly.

According to a physical quantity detection device 1 in the second embodiment, a circuit device 200 includes a BPF circuit 25 that outputs a signal obtained by sufficiently attenuating high-frequency noise contained in a digital signal ADO output from the ADC circuit 22. Thus, when demodulating an angular velocity signal AVO based on a detection signal SDT, a demodulation circuit 23 can suppress high-frequency noise generated by harmonics contained in the detection signal SDT from being folded back into the signal band. Furthermore, being formed as a digital circuit, the BPF circuit 25 does not involve a large circuit area and a large amount of power consumption, compared to a case where the BPF circuit 25 is formed as an analog circuit. Therefore, the physical quantity detection device 1 in the second embodiment can provide a low-noise physical quantity detection signal with a small scale of circuitry in circuit device 200. Other effects of the physical quantity detection device 1 in the second embodiment are the same as those of the physical quantity detection device 1 in the first embodiment.

### 3. Third Embodiment

Hereinafter, components in a third embodiment which are similar to those in the foregoing first embodiment are denoted by the same reference numerals. In addition, the components that have already been described in the first embodiment will not be described or will be described briefly. Thus, the description will be mainly focused on components different from those in the first embodiment.

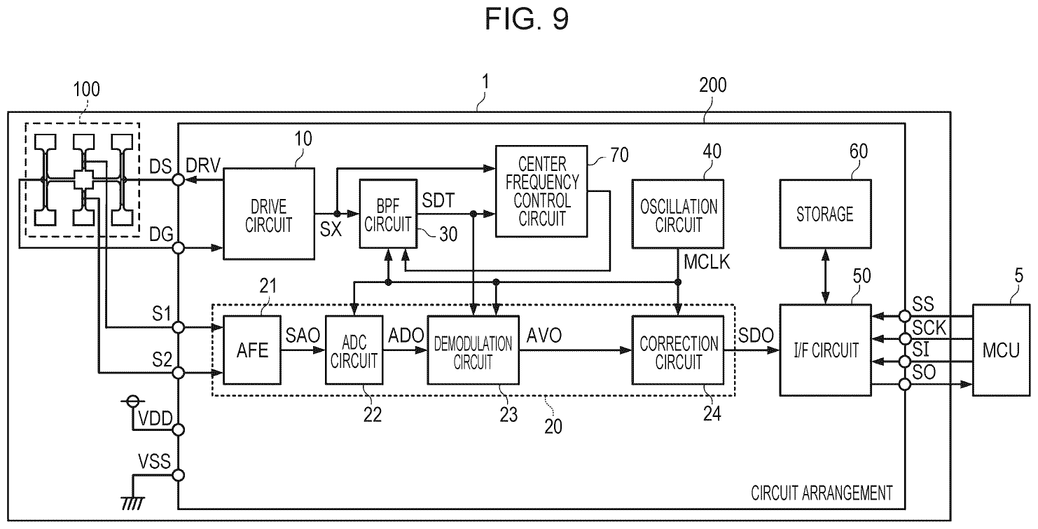

FIG. 9 is a functional block diagram of a physical quantity detection device 1 according to the third embodiment. As illustrated in FIG. 9, the physical quantity detection device 1 in the third embodiment includes a physical quantity detection element 100 and a circuit device 200. Since the configuration of the physical quantity detection element 100 is the same as in the first embodiment, the description thereof will not be given.

Similar to the first embodiment, the circuit device 200 includes a drive circuit 10, a detection circuit 20, a bandpass filter (BPF) circuit 30, an oscillation circuit 40, an interface (I/F) circuit 50, and a storage 60 and further includes a center frequency control circuit 70. In the circuit device 200, some of these components may be removed or replaced. Alternatively, some other elements may be added thereto. Since the configurations and processes of the drive circuit 10, the detection circuit 20, the oscillation circuit 40, the I/F circuit 50, and the storage 60 are the same as those in the first embodiment, the descriptions thereof will not be given.

The BPF circuit 30 operates in synchronization with a master clock signal MCLK. Therefore, when the frequency of the master clock signal MCLK is shifted from a target frequency, the center frequency of the BPF circuit 30 does not coincide with the frequency of a periodic signal SX, in which case the BPF circuit 30 may fail to sufficiently reduce some harmonics contained in a periodic signal SX. In the present embodiment, the center frequency control circuit 70 thus controls the center frequency of the BPF circuit 30, based on the difference in phase between the periodic signal SX and a detection signal SDT. More specifically, when the phase of the detection signal SDT is later than the phase of the periodic signal SX, the center frequency control circuit 70 increases the center frequency of the BPF circuit 30. When the phase of the detection signal SDT is earlier than the phase of the periodic signal SX, the center frequency control circuit 70 decreases the center frequency of the BPF circuit 30. In this way, the control is performed such that the center frequency of the BPF circuit 30 coincides with the frequency of the periodic signal SX. As a result, the BPF circuit 30 can sufficiently reduce harmonics contained in the periodic signal SX, thereby providing the detection signal SDT closer to a sine wave.

Using a digital signal output from the BPF circuit 30 as the detection signal SDT, a mixing circuit 231 removes almost all noise within the frequency bands of harmonics to be folded back into the signal band. It is thereby possible to demodulate the angular velocity signal AVO with great precision.

Other configurations of the physical quantity detection device 1 in the third embodiment are the same as in the first embodiment, and descriptions thereof will not be given accordingly.

According to a physical quantity detection device 1 in the third embodiment described above, even if a periodic signal SX based on a signal output from drivers 100a of a physical quantity detection element 100 is asynchronous to a master clock signal MCLK used for a BPF circuit 30 to generate a detection signal SDT, a circuit device 200 provides a detection signal SDT that is synchronized with the periodic signal SX. Therefore, the physical quantity detection device 1 in the third embodiment can accurately detect an angular velocity because the demodulation circuit 23 in the circuit device 200 demodulates an angular velocity signal AVO with great precision.

### 4. Modifications

The present disclosure is not limited to the foregoing embodiments and can undergo various modifications within the scope of the spirit of the present disclosure.

For example, the physical quantity detection device 1 in the foregoing first embodiment or third embodiment is provided with the BPF circuit 30 at the subsequent stage of the drive circuit 10. In addition, the physical quantity detection device 1 in the foregoing second embodiment is provided with the BPF circuit 25 at the subsequent stage of an ADC circuit 22. However, the physical quantity detection device 1 may be provided with both the BPF circuit 30 at the subsequent stage of the drive circuit 10 and the BPF circuit 25 at the subsequent stage of the ADC circuit 22. With this, the demodulation circuit 23 can demodulate an angular velocity signal AVO with greater precision.

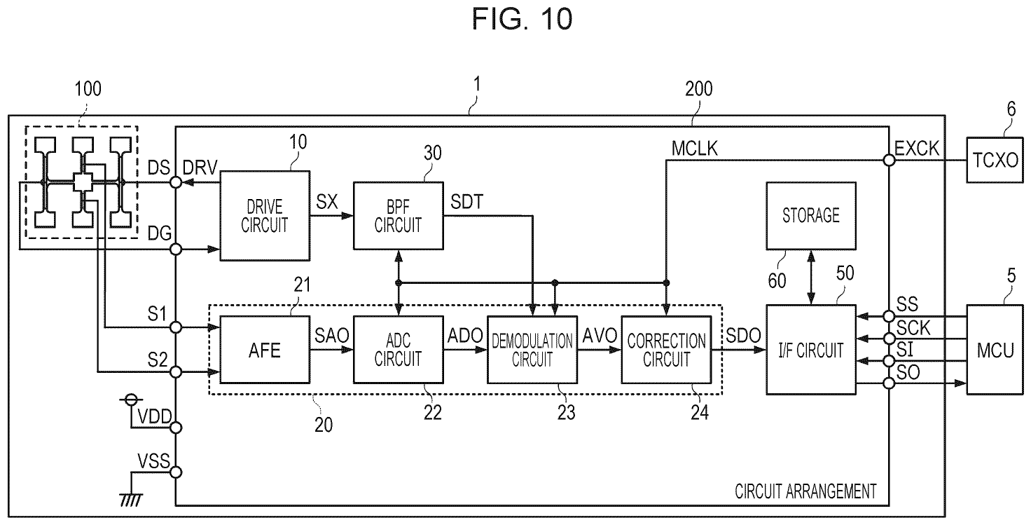

For example, in each of the foregoing embodiments, the master clock signal MCLK is generated inside a circuit device 200; however, the master clock signal MCLK may be supplied from the outside of the circuit device 200. As an example, a physical quantity detection device 1 illustrated in FIG. 10 includes a circuit device 200 that has, as an external connection terminal, a terminal EXCK at which a clock signal is to be supplied. The terminal EXCK is connected to a temperature compensated crystal oscillator (TCXO) 6. The TCXO 6 outputs a clock signal whose frequency does not largely fluctuate with temperature. The clock signal output from the TCXO 6 enters the circuit device 200 via the terminal EXCK and is then supplied as a master clock signal MCLK to the ADC circuit 22, the demodulation circuit 23, the correction circuit 24, and the BPF circuit 30. The physical quantity detection device 1 in the present modification can provide an angular velocity detection signal SDO with great precision because the ADC circuit 22, the demodulation circuit 23, the correction circuit 24, and the BPF circuit 30 all operate in accordance with the master clock signal MCLK having extremely small frequency deviations.

In each of the foregoing embodiments, the physical quantity detection device 1 includes a physical quantity detection element 100 that detects an angular velocity as a physical quantity; however, the physical quantity detection device 1 may include some physical quantity detection elements that detect physical quantities other than an angular velocity. For example, the physical quantity detection device 1 may include physical quantity detection elements that detect an acceleration, an angular acceleration, a velocity, a force, and some other physical quantities.

In each of the above-described embodiments, the physical quantity detection device 1 includes a single physical quantity detection element; however, the physical quantity detection device 1 may include a plurality of physical quantity detection elements. As an example, the physical quantity detection device 1 may include a plurality of physical quantity detection elements, each of which may detect a physical quantity by using one of two or more mutually orthogonal axes as a detection axis thereof. As another example, the physical quantity detection device 1 may include a plurality of physical quantity detection elements, each of which detects one of a plurality of physical quantities including an angular velocity, an acceleration, an angular acceleration, a velocity, and a force. In short, the physical quantity detection device 1 may serve as a composite sensor.

In each of the foregoing embodiments, as an example, the resonator element of the physical quantity detection element 100 is a double T-shaped quartz crystal resonator element. However, the resonator element of the physical quantity detection element which detects any given physical quantity may be, for example, of a tuning fork type or a comb tooth type or may be of a vibrating reed type having a triangular prism shape, a quadrangular prism shape, a cylindrical shape, or other shape. Instead of quartz crystal (SiO₂), the material of the resonator element of the physical quantity detection element may be a piezoelectric material, examples of which include piezoelectric single crystal such as lithium tantalate (LiTaO₃) or lithium niobate (LiNbO₃); and piezoelectric ceramic such as lead zirconate titanate (PZT) or may be a silicon semiconductor. Alternatively, the resonator element of the physical quantity detection element may have a structure in which a piezoelectric thin film, which is made of zinc oxide (ZnO), aluminum nitride (AlN), or other material interposed between drive electrodes, is mounted on a portion of a surface of a silicon semiconductor. For example, the physical quantity detection element may be a MEMS element. The MEMS is an abbreviation for micro electromechanical systems.

In addition, in each of the foregoing embodiments, a piezoelectric physical quantity detection element is used as an example; however, a physical quantity detection element which detects any given physical quantity is not limited to such a piezoelectric element. Alternatively, the piezoelectric physical quantity detection element may be an electrostatic capacitance, electrodynamic, eddy current, optical, strain gauge, or other type of element. A detection method employed by a physical quantity detection element is not limited to a method using vibrations; alternatively, the detection method may be, for example, a method using light, rotations, or fluids.

The foregoing embodiments and modifications are merely examples and are not intended to limit the present disclosure. For example, some of the embodiments and the modifications may be combined together as appropriate.

The present disclosure may include a configuration that is substantially equivalent to any of the configurations described in the foregoing embodiments; for example, the present disclosure may include a configuration that provides the same function, method, and result or a configuration that achieves the same object and effect. The present disclosure may include a configuration in which, of components described in the embodiments, non-essential ones are replaced with others. The present disclosure may further include a configuration that can produce the same effects as the configurations described in the embodiments or a configuration that can achieve the same object as the configurations described in the embodiments. The present disclosure may further include a configuration conceived by adding a known technology to the configurations described in the embodiments.

The following aspects are derived from the foregoing embodiments and modifications.

A first aspect of the present disclosure is a circuit device connected to a physical quantity detection element that has a driver and a detector. The circuit device includes a drive circuit that drives the driver and that generates a periodic signal, based on a signal output from the driver; a detection circuit that generates a physical quantity detection signal related to a physical quantity detected by the detector, based on a signal output from the detector; and a bandpass filter circuit that receives the periodic signal and that outputs a detection signal through a digital process. The detection circuit includes an analog front end that amplifies the signal output from the detector; an analog-to-digital conversion circuit that converts a signal output from the analog front end into a digital signal; and a demodulation circuit that demodulates a physical quantity signal contained in the digital signal output from the analog-to-digital conversion circuit, based on the detection signal. The detection circuit generates the physical quantity detection signal, based on the demodulated physical quantity signal.

A circuit device, as described above, includes a bandpass filter circuit that outputs a detection signal obtained by sufficiently attenuating harmonics contained in a periodic signal. Thus, when demodulating a physical quantity signal based on the detection signal, a demodulation circuit can suppress high-frequency noise generated by harmonics contained in the detection signal from being folded back into the signal band. Furthermore, being formed as a digital circuit, the bandpass filter circuit does not involve a large circuit area and a large amount of power consumption, compared to a case where the bandpass filter circuit is formed as an analog circuit. Therefore, this circuit device can provide a low-noise physical quantity detection signal with a small scale of circuitry therein.

Using a digital circuit to perform a bandpass filter process and a process of demodulating the physical quantity signal, the circuit device can reduce low-frequency noise, such as 1/f noise, generated within the signal band, compared to the related art in which an analog circuit performs a bandpass filter process or a demodulation process. Therefore, this circuit device can provide a low-noise physical quantity detection signal.

In the circuit device according to the first aspect, the demodulation circuit may include a mixing circuit that uses the digital signal output from the analog-to-digital conversion circuit as a detected signal to mix the detected signal with the detection signal.

A second aspect of the present disclosure is a circuit device connected to a physical quantity detection element that has a driver and a detector. The circuit device includes a drive circuit that drives the driver and that generates a periodic signal, based on a signal output from the driver; a detection circuit that generates a physical quantity detection signal related to a physical quantity detected by the detector, based on a signal output from the detector. The detection circuit includes an analog front end that amplifies the signal output from the detector; an analog-to-digital conversion circuit that converts a signal output from the analog front end into a digital signal; a bandpass filter circuit that receives the digital signal output from the analog-to-digital conversion circuit; and a demodulation circuit that uses the periodic signal as a detection signal to demodulate a physical quantity signal contained in a signal output from the bandpass filter circuit, based on the detection signal. The detection circuit generates the physical quantity detection signal, based on the demodulated physical quantity signal.

A circuit device, as described above, includes a bandpass filter circuit that outputs a signal obtained by sufficiently attenuating high-frequency noise contained in a digital signal output from an analog-to-digital conversion circuit. Thus, when demodulating a physical quantity signal based on the detection signal, a demodulation circuit can suppress high-frequency noise generated by harmonics contained in the detection signal from being folded back into the signal band. Furthermore, being formed as a digital circuit, the bandpass filter circuit does not involve a large circuit area and a large amount of power consumption, compared to a case where the bandpass filter circuit is formed as an analog circuit. Therefore, this circuit device can provide a low-noise physical quantity detection signal with a small scale of circuitry therein.

Using a digital circuit to perform a bandpass filter process and a process of demodulating the physical quantity signal, the circuit device can reduce low-frequency noise, such as 1/f noise, generated within the signal band, compared to the related art in which an analog circuit performs a bandpass filter process or a demodulation process. Therefore, this circuit device can provide a low-noise physical quantity detection signal.

In the second aspect of the circuit device, the demodulation circuit may include a mixing circuit that uses the signal output from the bandpass filter circuit as a detected signal to mix the detected signal with the detection signal.

In the second aspect, the circuit device may further include a center frequency control circuit that controls a center frequency of the bandpass filter circuit, based on a difference in phase between the periodic signal and the detection signal.

A circuit device, as described above, can provide the detection signal synchronized with the periodic signal, even if a periodic signal based on a signal output from the driver is asynchronous to a clock signal for which the bandpass filter circuit generates the detection signal. Therefore, this circuit device can detect a physical quantity with great precision because the demodulation circuit precisely demodulates the physical quantity signal.

In the second aspect of the circuit device, the analog-to-digital conversion circuit may be a delta-sigma analog-to-digital conversion circuit.

In a circuit device, as described above, an analog-to-digital conversion circuit reduces noise within the signal band which is contained in a digital signal output from an analog-to-digital conversion circuit, because of the noise-shaping effect of a delta-sigma analog-to-digital conversion circuit. Furthermore, this circuit device uses a 1-bit signal as the digital signal output from the analog-to-digital conversion circuit. It is thus possible to realize a compact demodulation circuit with a simple configuration.

According to a third aspect is a physical quantity detection device that includes an aspect of the circuit device and the physical quantity detection element.

A physical quantity detection device, as described above, includes a circuit device in which a bandpass filter circuit outputs a detection signal obtained by sufficiently attenuating harmonics contained in a periodic signal or outputs a signal obtained by sufficiently attenuating high-frequency noise contained in a digital signal output from an analog-to-digital conversion circuit. It is thus possible to suppress high-frequency noise generated by harmonics contained in the detection signal from being folded back into a signal band when the demodulation circuit demodulates a physical quantity signal based on a detection signal. Furthermore, being formed as a digital circuit, the bandpass filter circuit does not involve a large circuit area and a large amount of power consumption, compared to a case where the bandpass filter circuit is formed as an analog circuit. Therefore, this physical quantity detection device can provide a low-noise physical quantity detection signal with a small scale of circuitry in the circuit device.

In a physical quantity detection device, as described above, a circuit device uses a digital circuit to perform a bandpass filter process and a process of demodulating the physical quantity signal. Thus, the circuit device can reduce low-frequency noise, such as 1/f noise, generated within the signal band, compared to the related art in which an analog circuit performs a bandpass filter process or a demodulation process. Therefore, this physical quantity detection device can provide a low-noise physical quantity detection signal.

What is claimed is:

1. A circuit device connected to a physical quantity detection element that includes a driver and a detector, the circuit device comprising:
a drive circuit that drives the driver and that generates a periodic signal, based on a signal output from the driver;
a detection circuit that generates a physical quantity detection signal related to a physical quantity detected by the detector, based on a signal output from the detector; and
a bandpass filter circuit that receives the periodic signal and that outputs a detection signal through a digital process,
the detection circuit including
an analog front end that amplifies the signal output from the detector,
an analog-to-digital conversion circuit that converts a signal output from the analog front end into a digital signal, and
a demodulation circuit that demodulates a physical quantity signal contained in the digital signal output from the analog-to-digital conversion circuit, based on the detection signal,
the detection circuit generating the physical quantity detection signal, based on the demodulated physical quantity signal.

2. The circuit device according to claim 1, wherein
the demodulation circuit includes a mixing circuit that uses the digital signal output from the analog-to-digital conversion circuit as a detected signal to mix the detected signal with the detection signal.

3. A circuit device connected to a physical quantity detection element that has a driver and a detector, the circuit device comprising:
a drive circuit that drives the driver and that generates a periodic signal, based on a signal output from the driver; and
a detection circuit that generates a physical quantity detection signal related to a physical quantity detected by the detector, based on a signal output from the detector,
the detection circuit including
an analog front end that amplifies the signal output from the detector,
an analog-to-digital conversion circuit that converts a signal output from the analog front end into a digital signal,
a bandpass filter circuit that receives the digital signal output from the analog-to-digital conversion circuit, and
a demodulation circuit that uses the periodic signal as a detection signal to demodulate a physical quantity signal contained in a signal output from the bandpass filter circuit, based on the detection signal,
the detection circuit generating the physical quantity detection signal, based on the demodulated physical quantity signal.

4. The circuit device according to claim 3, wherein
the demodulation circuit includes a mixing circuit that uses the signal output from the bandpass filter circuit as a detected signal to mix the detected signal with the detection signal.

5. The circuit device according to claim 1, further comprising:
a center frequency control circuit that controls a center frequency of the bandpass filter circuit, based on a difference in phase between the periodic signal and the detection signal.

6. The circuit device according to claim 1, wherein
the analog-to-digital conversion circuit is a delta-sigma analog-to-digital conversion circuit.

7. A physical quantity detection device comprising:
the circuit device according to claim 1; and
the physical quantity detection element.
